(19) United States
(12) Patent Application Publication
(10) Pub. No.: US 2016/0288314 A1
(43) Pub. Date: Oct. 6, 2016

(54) VARIABLE FRICTION GRIP PATTERN

(71) Applicant: FISKARS BRANDS, INC., Madison, WI (US)

(72) Inventors: Colin Roberts, Madison, WI (US); Steven Stokes, Fitchburg, WI (US)

(73) Assignee: FISKARS BRANDS, INC., Madison, WI (US)

(21) Appl. No.: 14/675,466

(22) Filed: Mar. 31, 2015

(51) Int. Cl. B25G 1/10

(52) U.S. Cl. CPC B25G 1/102

(57) ABSTRACT

A hand operated tool includes a gripping surface. The gripping surface defines a first plurality of elements situated in at least one first region on the surface, the at least one first region defining a first friction level; a second plurality of elements situated in at least one second region on the surface, the at least one second region defining a second friction level, wherein the second friction level defines a relatively lesser amount of friction than the first friction level; and a third plurality of elements defining a transitional friction level between the first friction level and the second friction level, the third plurality of elements interconnecting each of the at least one first regions with each of the at least one second regions.

### FIELD

The present disclosure relates to hand operated tools. More particularly, the present disclosure relates to grip patterns for hand operated tools.

### BACKGROUND

This section is intended to provide a background or context to the disclosure recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

It is generally known to provide a hand operated tool. Hand operated tools include cutting-type tools and strike-type tools. For example, hand operated cutting tools include shears, loppers, pruners, and the like. In comparison, hand operated strike-type tools include hammers, sledgehammers, mauls, axes, and the like. Typically, hand operated tools are either one-hand operated or two-hand operated. For example, a user can hold and operate a small axe (less than two feet in length) with only one hand. However, a larger axe (e.g., three feet or more in length) typically requires the user to use two-hands to hold and operate.

Typically, both hand operated striking and cutting tools include a gripping surface for a user to grip when handling the tool. However, in operation, the user's hand(s) can slide and slip on the grip surface. This can lead to a loss of control of the tool and/or an irritability of the hand(s) (e.g., a formation of blisters). For example, a sliding action can cause blisters and other irritability on the user's hand, which is undesirable. In comparison, a slipping action can result in the tool becoming “free” from the user's hand(s) (e.g., thrown, dropped, etc.). A loose tool can cause injury to the user and/or damage to the work piece. Accordingly, one option for reducing the likelihood of slipping and/or sliding on the grip surface is to use gloves. Often times however, gloves are not readily available to the user and may provide an inadequate level of feel that users typically desire. Accordingly, an improved grip surface is desirable.

### SUMMARY

One embodiment relates to a hand operated tool. The hand operated tool includes a tool head, a handle coupled to the tool head, and a surface disposed on the handle. The surface defines a first plurality of elements situated in at least one first region on the surface, the at least one first region defining a first friction level; a second plurality of elements situated in at least one second region on the surface, the at least one second region defining a second friction level, wherein the second friction level defines a relatively lesser amount of friction than the first friction level; and a third plurality of elements defining a transitional friction level between the first friction level and the second friction level, the third plurality of elements interconnecting each of the at least one first regions with each of the at least one second regions. According to one embodiment, each element in the first, second, and third pluralities of elements are arranged on a dot matrix pattern.

Another embodiment relates to a hand operated tool including a surface for gripping a handle of the tool. The surface includes at least one first region with a plurality of first elements in each at least one first region, wherein each at least one first region defines a first friction level, wherein each at least one first region is positioned on an intended stationary hand position area on the surface; at least one second region with a second plurality elements in each at least one second region, wherein each at least one second region defines a second friction level defining a relatively lesser amount of friction than the first friction level, wherein each at least one second region is positioned in an intended movable hand position area on the surface; and a third plurality of elements defining a transitional friction level between the first friction level and the second friction level, wherein the third plurality of elements interconnects each at least one first region with each at least one second region.

Still another embodiment relates to a method for a method for making a hand tool having a gripping surface with a variable friction pattern. The method includes providing a first plurality of elements defining a first friction level, the first plurality of elements positioned on a stationary hand position area on the gripping surface; providing a second plurality elements defining a second friction level, the second friction level being less than the first friction level, wherein the second plurality of elements are positioned on a movable hand position area on the gripping surface; providing a third plurality of elements defining a transitional friction level between the first friction level and the second friction level; and interconnecting the third plurality of elements with the first and second pluralities of elements.

### BRIEF DESCRIPTION OF THE DRAWINGS

FIG. 1 is a side view of a one-hand operated striking tool, such as a hammer, according to an exemplary embodiment.

FIG. 2 is another side view of the hammer of FIG. 1, according to an exemplary embodiment.

FIG. 3 is a side view of a variable friction grip surface for a hand operated tool, according to an exemplary embodiment.

FIG. 4 is another side view of the variable friction grip surface of FIG. 3, according to an exemplary embodiment.

FIG. 5 is a top perspective view of a variable friction grip surface for a hand operated tool, according to an exemplary embodiment.

FIG. 6 is a cross-sectional side view of a variable friction grip surface for a hand operated tool, according to an exemplary embodiment.

FIG. 7 is another cross-sectional side view of a variable friction grip surface for a hand operated tool, according to an exemplary embodiment.

FIG. 8 is still another cross-sectional side view of a variable friction grip surface for a hand operated tool, according to an exemplary embodiment.

FIG. 9 is a top perspective view of a variable friction grip surface for a hand operated tool, according to another exemplary embodiment.

FIG. 10 is a schematic image of a two-hand operated strike tool, shown as an axe, in an initial position of an impact stroke, according to an exemplary embodiment.

FIG. 11 is a schematic image of a two-hand operated strike tool, shown as an axe, at an approximate midpoint position of an impact stroke, according to an exemplary embodiment.

FIG. 12 is a schematic image of a two-hand operated strike tool, shown as an axe, at an end position of an impact stroke, according to an exemplary embodiment.

### DETAILED DESCRIPTION

Referring to Figures generally, a variable friction grip surface for a hand-operated tool is shown according to various embodiments herein. According to the present disclosure, the variable friction grip surface defines a pattern of elements arranged on a dot matrix pattern. According to one embodiment, the grip surface includes a plurality of first elements, a plurality of second elements, and a plurality of third elements that interconnects the pluralities of first and second elements. The plurality of first elements is of a relatively larger scale than the pluralities of second and third elements. The plurality of second elements is of a relatively smaller scale than the pluralities of first and third elements. The plurality of third elements is of a variable scale ranging from a scale that is relatively close in size to the large scale of the plurality of first elements to a scale that is relatively close in size to the small scale of the plurality of second elements. Due to the range in scale, the plurality of third elements provides a relatively smoothly frictional transition between the plurality of first elements and the plurality of second elements. The scale refers to the overall size of each element in the pluralities of element. Varying the scale of the elements impacts the coefficient of friction on the grip surface. The relatively larger scale of the plurality of first elements defines a relatively greater amount of friction than both of the pluralities of the second and third elements. In comparison, the relatively smaller scale of the plurality of second elements defines a relatively lower amount friction relative to the pluralities of the first and third elements. According to the present disclosure, each of the pluralities of elements is strategically positioned in zones or regions longitudinally and/or circumferentially on the grip surface to optimize performance and use of the hand operated tool.

According to the present disclosure, the regions are arranged based on a type of hand operated tool. For example, hand operated tools may include one-handed operated strike tools with a stationary hand position (e.g., a hammer), two-handed operated strike tools with a moving hand position (e.g., a sledgehammer), and one-handed and two-handed operated cutting tools with stationary hand positions (e.g., pruners, loppers, shears, etc.). A stationary hand position refers to a hand grip that experiences little relative movement during the use of the tool. In comparison, a moving hand position refers to a hand position where a hand experiences movement during the use of the tool. In some grip areas such as moving hand position areas, it is desirable to have a relatively lower amount of friction to allow the hand to move or slide easily on the grip surface. In other areas such as stationary hand position areas, it is desirable to have a relatively higher amount of friction to minimize movement of the hand on the grip surface. According to the present disclosure, the high friction plurality of first elements are positioned in regions on the grip surface where a stationary hand position is likely to be experienced whereas the low friction plurality of second elements are positioned in regions on the grip surface where a moving hand position is likely to be experienced. Accordingly, high friction zones are positioned in areas where the user is likely to exert a maximum effort, and the greatest amount of friction between the handle and the hand is desired to prevent the tool from slipping out of the user's hand. In comparison, the low friction zones are positioned in areas where high levels of friction may cause irritability and a lack of control over operation of the tool. Accordingly, the relative positioning of the zones on various tool grip surfaces (e.g., hammers, two-hand operated axes, sledgehammers, mauls, pruners, loppers, etc.) may vary from tool type-to-tool type to accommodate the different hand position operating dynamics of each tool. As a result, a custom variable friction grip surface may be provided for each type of tool, which may reduce the likelihood of blister formation, increase a user's feel of control over the tool, and provide a better operational experience over conventional grip surfaces on hand operated cutting tools.

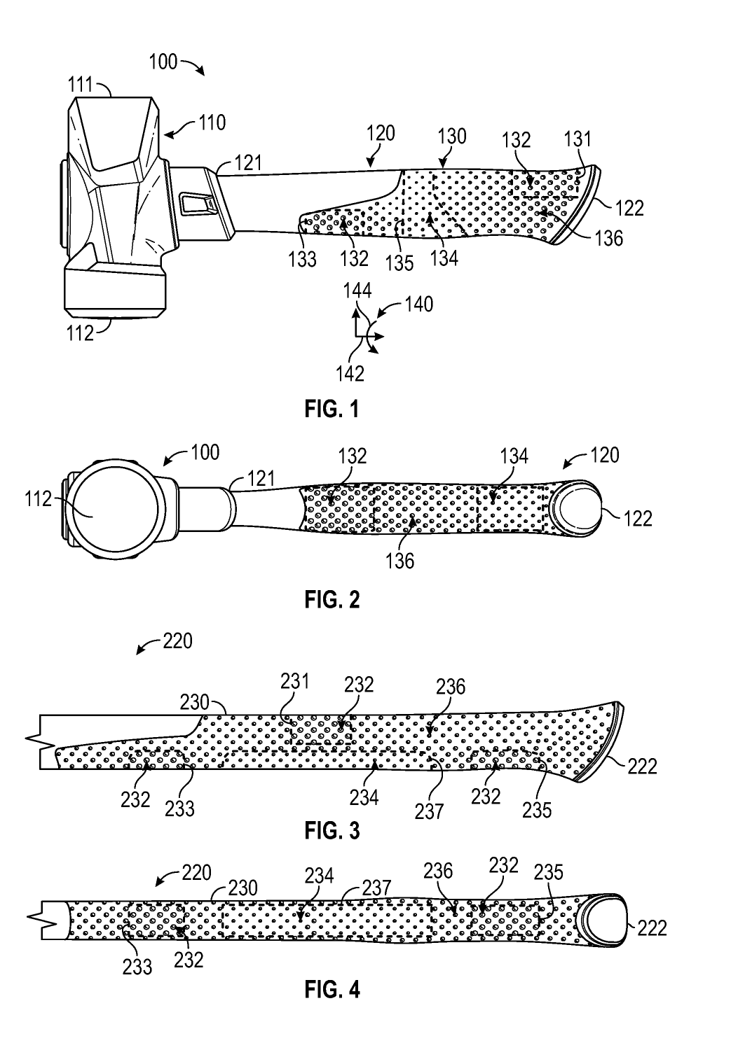

Referring now to FIGS. 1-2, a side view (FIG. 1) and an impact end view (FIG. 2) of a one-hand operated striking tool, shown as a hammer 100, with a variable friction grip surface is shown according to an exemplary embodiment. The hammer 100 includes a tool head 110 attached to a handle 120. The handle 120 may be attached to the tool head 110 through any type of attachment mechanism (e.g., an interference fit relationship relative to an aperture/opening in the tool head, a coupling device, etc.). The tool head 110 includes a face 112 (e.g., impact end, etc.) and an end 111 (e.g., wedge, second face, claw, peen, etc.) positioned on an opposite end of the tool head 110 relative to the face 112. In one embodiment, the face 112 is intended to strike an object of interest (e.g., a nail, etc.). In other embodiments, the end 111 may also be used to strike an object. The handle 120 includes a first end 121 positioned closest to the tool head 110 and a second end 122 positioned furthest from the tool head 110.

It is important to note that while a one-hand operated hammer 100 is depicted in FIGS. 1-2, as mentioned above, many other types of hand operated tools may include the variable friction grip surface of the present disclosure such that the particular implementation of FIGS. 1-2 is not meant to be limiting. For example, other embodiments may include other one-hand operated striking tools (e.g., a hatchet), two-hand operated striking tools (e.g., an axe, a sledgehammer, etc.), one-hand operated cutting tools (e.g., a pruner), and/or two-hand operated cutting tools (e.g., a lopper). Accordingly, the handle and tool head configurations may differ based on the type of tool. For example, in some embodiments, the hammer of FIGS. 1-2 may be structured as a claw-type hammer. Further, while the handle 120 is shown to be substantially oval-shaped. In other embodiments, other shapes (e.g., completely cylindrical) and contours are possible. All such variations are intended to fall within the spirit and scope of the present disclosure.

Referring back to FIGS. 1-2, a surface 130 is disposed on the handle 120. The surface 130 is structured as a hand gripping area for the tool 100. The surface 130 may be constructed from rubber, plastic, and any other material used in connection with the fabrication of grip surfaces. In regard to coordinate system 140, the surface 130 extends in a longitudinal direction 142 from at or near the second end 122 of the handle 120 towards the tool head 110. At various positions longitudinally along the handle 120, the surface 130 completely surrounds the handle 120 (i.e., in a circumferential direction 144). As shown, the surface 130 is disposed over only a part of the longitudinal length of the handle 120. However, in various other embodiments, the surface 130 may extend longitudinally the full length of the handle, may completely surround the handle at all longitudinal positions, may only partially surround the handle at all longitudinal positions, and variations thereof.

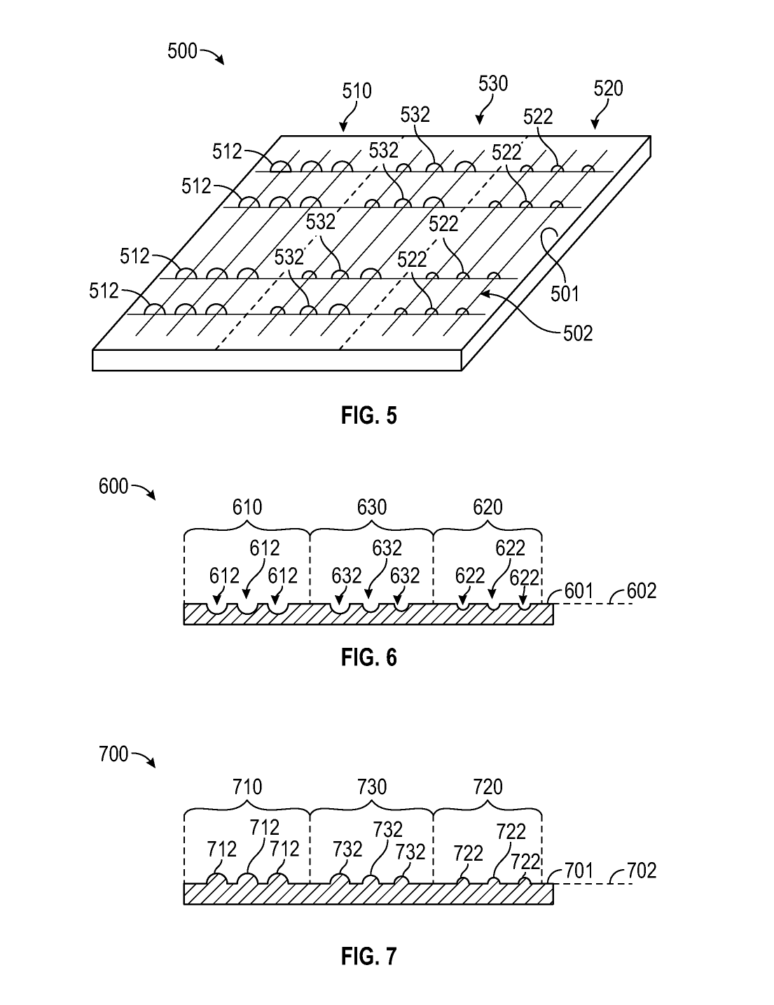

The surface 130 defines a first element 132, a second element 134, and a third element 136. A plurality of first elements 132 are positioned in regions 131 and 133 (e.g., zones, areas, parts, etc.) on the surface 130 while a plurality of second elements 134 are positioned in a region 135 on the surface. A plurality of third elements 136 interconnects the plurality of first elements 132 with the plurality second elements 134. As shown, the first, second, and third elements 132, 134, and 136 are structured as depressions (e.g., indentations, dents, cavities, etc.) defined by the surface 130. The depressions may have any type of shape. In the embodiment depicted, each of the first, second, and third elements 132, 134, and 136 has a partial sphere shape (e.g., dimple, pit, etc.). However, in other embodiments, the shape of the elements may include, but is not limited to, a conical shape, a prism shape, a wedge that defines a circumferential groove, etc. Furthermore, as shown and described in regard to FIGS. 5-8 herein, the elements may also be structured as protrusions that extend above a nominal level of the surface and/or as a combination of protrusions and depressions.

In the embodiment depicted, each of the first element 132, the second element 134, and the third element 136 have the same shape but are of a different scale. As used herein, the term “scale” is meant to refer to the overall size of the element. For example, in regard to the partial spheres of FIGS. 1-2, the term “scale” includes both of the diameter and depth of depression of the partial sphere. In the embodiment shown in FIGS. 1-2, the first element 132 is of a relatively larger scale than the second element 134 and the third element 136. The effect is that the partial sphere shaped first element 132 is both deeper (in a direction inwards toward the handle 120) and of a larger diameter than the diameters and depths of the second element 134 and third element 136. Relatively larger scale elements correspond with more disruption in the surface 130 from being a smooth or relatively smooth surface. As a result, the relatively larger scale first elements increase a coefficient of friction of the surface 130 where they are located (e.g., regions 131 and 133). In comparison, the second element 134 is of a relatively smaller scale than both the first element 132 and the third element 136. As a result, the region 135 defines a relatively lower coefficient of friction than regions 131, 133 and the remaining area of the surface 130 that defines the plurality of third elements 136. While of the same shape as the first element 132 and the second element 134, the third element 136 is of a variable scale. The third elements 136 that are positioned relatively closer to (e.g., adjacent) the second elements 134 are of a smaller scale than the third elements 136 that are positioned relatively closer to (e.g., adjacent) first elements 132. In between these locations and moving from the plurality of first elements 132 to the plurality of second elements 134, the scale of the third elements 136 continuously decreases until the region of second elements is reached (e.g., region 135). Accordingly, the coefficient of friction provided by third elements 136 adjacent to first elements 132 may be equal while the coefficient of friction provided by third elements 136 adjacent to second elements 134 may be equal. While the coefficient of friction is relatively constant in the regions including a plurality of the first elements 132 and a plurality of the second elements 134, due to the variable scale characteristic of the plurality of third elements 136, the coefficient of friction in the region where a plurality of third elements 136 is located is substantially not constant. However, due to the substantially continuous gradation of the coefficient of friction by the third elements 136 between the first and second elements 132 and 136, the transition between the plurality of first elements and the plurality of second elements is a relatively smooth transition in frictional properties from one region to another. This type of transition avoids abrupt changes in frictional performance between grip regions that results in increased tool control and comfort for most hand sizes. This feature may also provide the appearance of a smooth aesthetic transition between different friction grip regions.

As shown in FIGS. 1-2, the relative positions of the regions including the first, second, and third of elements 132, 134, and 136 vary as a function of at least one of a longitudinal position along the surface 130 and as a circumferential position about the handle 120. The relative positions depicted in FIGS. 1-2 are specific to the one-hand operated hammer 100 shown in FIGS. 1-2. As shown, a plurality of first elements 132 are positioned in a region 131 and a region 133, while a plurality of second elements 134 are positioned in a region 135. The region 131 is located near the end 122 of the handle 120 on an upper portion of the surface 130. “Upper” refers to a position that is relatively closer to the end 111 than the face 112 of the tool head 110. In comparison, the region 133 is longitudinally closer to the end 121 on a lower portion of the surface. “Lower” refers to a position that is relatively closer to the face 112 than the end 111 of the tool head 110. The region 135 extends from an upper area to a lower area on the surface 130 in between the region 131 and the region 133. A plurality of third elements 136 are positioned in between the regions 131 and 135 and the regions 133 and 135. As mentioned above, due to the variable scale of the third elements 136, a relatively smooth frictional transition is provided by the plurality of third elements between each of the regions.

In operation, a user typically places their palm over the region 131 to grip and swing the hammer 100. To substantially prevent the hammer 100 from slipping within their grip, the highest friction first elements 132 are provided in the region 131. Sometimes, a user may use the end 111 for various other functions (e.g., to strike an area through a crevice where the larger face 112 will not fit through). Accordingly, the highest friction first elements 132 are also provided in the region 133. In operation, when the user places their palm over the regions 131 and 133, their palm may experience a relatively high amount of friction. However, as shown, the region 131 does not completely surround the handle 120 (e.g., about a circumferential direction 144). In turn, the plurality of third elements 136 and region 135 that includes a plurality of second elements 134 may contact the fingers of the user while the user's palm is in contact with the high friction region 131. This may be advantageous because a user may move their fingers during the impact stroke despite their palm remaining stationary. The relatively low friction finger-contact areas permit relatively easy sliding which may increase control over the tool as one or more fingers may readily move to help support/control the tool during use. Accordingly, a high amount of friction may be undesirable in those finger-contact areas surrounding region 131.

As shown in FIGS. 1-2 (and in FIGS. 3-4), the surface does not include any regions where elements are omitted. Rather, the first, second, and third elements are disposed throughout (longitudinally and circumferentially) the grip surface in a dot matrix pattern (see FIG. 5). However, in various other embodiments, the plurality of second elements (the relatively lowest friction generating elements) may be replaced with a relatively smooth region on the surface or the relatively smooth region on the surface may be included with the pluralities of first, second, and third elements. In each of these configurations, the relatively smooth region is characterized by the omission of any elements, which are shown and described herein. Accordingly, the relatively smooth region defines a lower amount of friction than the amounts of friction defined by each of the first, second, and third pluralities of elements. While some embodiments may include relatively smooth grip surface regions, the placement of these regions is still dependent on the tool type in order to provide a custom variable friction grip surface that optimizes use of the particular tool.

Referring now to FIGS. 3-4, another pattern of elements for a variable friction grip surface is shown according to an exemplary embodiment. The pattern depicted in FIGS. 3-4 may be used for a different type of tool than the one-handed hammer 100 in FIGS. 1-2. For example, the pattern depicted in FIGS. 3-4 may be utilized with a two-hand operated tool, such as a sledgehammer.

FIG. 3 depicts a side view of a handle for a tool, according to an exemplary embodiment, while FIG. 4 depicts a different side view of the handle for the tool, according to an exemplary embodiment. As shown, the handle 220 includes a surface 230 that defines a variable friction grip. Similar to the surface 130 of FIGS. 1-3, the surface 230 defines a first element 232, a second element 234, and a third element 236. A plurality of first elements 232 are positioned in a region 231, a region 233, and a region 235. A plurality of a second elements 234 are positioned in a region 237, while a plurality of third elements 236 interconnect each region including the plurality of first elements 232 and the plurality of second elements 234. The first element 232 has the same structure and function as the first element 132. The second element 234 has the same structure and function as the second element 134 and the third element 236 has the same structure and function as the third element 136. Accordingly, the surface 230 provides a similar variable friction grip surface as the surface 130 but with a different relative position of high friction areas (regions 231, 233, and 235), low friction areas (region 237), and transitional or variable frictional regions (position of third elements 236).

FIGS. 3-4 recognize that each type of hand operated tool typically has different intended hand position(s) (e.g., only a stationary hand position, a stationary and a moving hand position, etc.). In this regard, the variable friction surface of the present disclosure is tailored to each type of tool to optimize the comfort and use of that tool while reducing the likelihood of irritability, such as the formation of blisters, from using that tool. As can be appreciated, the relative positioned of each of the high, low, and transitional frictional areas is highly variable based on the type of tool. While only a few examples are shown herein in regards to FIGS. 1-4 and FIGS. 10-12, it should be understood that all such configurations are intended to fall within the spirit and scope of the present disclosure.

Referring now to FIGS. 5-8, variable friction grip surfaces for a hand operated tool are shown according to various exemplary embodiments. In FIGS. 5-8, various specific structures that may be used to provide a variable friction grip are depicted. While different reference numerals are used for clarity, it should be understood that the phrases “first element” or “plurality of first elements” is intended to refer to elements that provide the highest amount of friction, analogous to first element 132 and first element 232. The same is true for the phrases “second element” and “third element” (similarly, “plurality of second elements” and “plurality of third elements”) that refer to elements that provide the lowest coefficient of friction (second elements) and elements that provide a variable or transitional amount of friction (third elements).

FIG. 5 depicts a top perspective view of a variable friction grip surface according to an exemplary embodiment. A grip structure 500 includes a surface 501 that includes a first region 510 (e.g., zone, area, sector, part, portion, fragment, etc.), a second region 520, and a third region 530 interconnecting the first region 510 with the second region 520. While only one first region 510, second region 520, and third region 530 are depicted in FIG. 5, it should be understood that the a variable friction grip surface for a hand operated tool may include many first regions, second regions, and third regions.

The surface 501 defines a first plurality of elements 512 situated the first region 510, a second plurality of elements 522 situated in the second region 520, and a third plurality of elements 532 arranged in the third region 530. As shown, each element in the first plurality of elements 512, the second plurality of elements 522, and the third plurality of elements 532 is of a homogenous shape. In contrast to FIGS. 1-4, in this embodiment, each element in the first plurality of elements 512, the second plurality of elements 522, and the third plurality of elements 532 is structured as a projection (e.g., protrusion, etc.) extending above a nominal level of the surface 501. In this example, each element in the first plurality of elements 512, the second plurality of elements 522, and the third plurality of elements 532 is of a partial sphere shape (e.g., a dimple). However, in other embodiments, the shape of each element may include, but is not limited to, a prism shape, a pyramid shape, a cylinder shape, etc.

The first plurality of elements 512 is of a relatively larger scale than both the second plurality of elements 522 and the third plurality of elements 532. The relative larger scale corresponds with a relatively greater amount of surface variation, which increases the coefficient of friction in the first region 510 relative to the second and third regions 520 and 530. In comparison, the second plurality of elements 522 is of a relatively smaller scale than either the first or third pluralities of elements 512 and 532. Accordingly, the relatively smaller scale has the least amount of surface variation, which corresponds with the smallest coefficient of friction. In comparison, the third plurality of elements 532 has a variable scale, which defines a variable friction level. Elements of the third plurality of elements 532 situated closer to the second plurality of elements 522 are of a scale close to that of the second plurality of elements 522. Elements of the third plurality of elements 532 situated closer to the first plurality of elements 512 are of a scale closer to that of the first plurality of elements 512. In between these two end points, the scale varies as a substantially continuous gradation. Accordingly, a user that slides their hand from the first region 510 to the second region 520 or vice versa experiences little abrupt changes in friction.

As shown, each element in the first plurality of elements 512, the second plurality of elements 522, and the third plurality of elements 532 is disposed on a single, dot matrix 502 pattern. Advantageously, this configuration provides for an ease of manufacturing. For example, if the elements are structured as partial-sphere depressions, a tool that has a variable diameter body extending to a narrow tip (e.g., a punch) may vary the depth that is it inserted into the surface. Due to the variable diameter body, more insertion into the surface corresponds with a deeper and larger diameter depression. In this example, the tool may be inserted the furthest for the first plurality of elements, the least for the second plurality of elements, and a variable depth for the third plurality of elements. Due to being on a dot matrix pattern, relatively less complex tooling may then be utilized to control the insertion of the tool. This may increase efficiency of production of the variable friction grip surface of the present disclosure.

Referring now to FIGS. 6-8, cross-sectional views of a grip structure with variable friction grip surface are shown according to various exemplary embodiments. Each of the embodiments depicted in FIGS. 6-8 depict homogenous shaped elements but of differing scales.

FIG. 6 depicts a grip structure 600 that includes a surface 601 that includes a first region 610, a second region 620, and a third region 630 interconnecting the first region 610 with the second region 620. The surface 601 defines a plurality of first elements 612 situated in the first region 610, a plurality of second elements 622 situated in the second region 620, and a plurality of third elements 632 situated in the third region. As shown, the plurality of first elements 612 are of a relatively larger scale than the pluralities of the second and third elements 622 and 632, and the plurality of second elements 622 is of a relatively smaller scale than both the pluralities of first elements 612 and the plurality of third elements 632. Like in FIG. 5, the surface 601, therefore, provides for a variable friction grip surface. Relative to FIG. 5, in this embodiment, each element in the pluralities of elements 612, 622, and 632 are structured as depressions (e.g., recesses, indents, pits, cavities, craters, etc.) that are of a partial sphere-shape. As shown, each element in the pluralities of elements 612, 622, and 632 extend below a nominal level 602 of the surface 601. The deeper and bigger the structure of the element, like the first plurality of elements 612, corresponds with relatively more surface variation and a higher amount of friction. This type of element structure is utilized in the embodiments depicted in FIGS. 1-4.

FIG. 7 depicts a grip structure 700 that includes a surface 701 that includes a first region 710, a second region 720, and a third region 730 interconnecting the first region 710 with the second region 720. The surface 701 defines a plurality of first elements 712 situated the first region 710, a plurality of second elements 722 situated in the second region 720, and a plurality of third elements 732 situated in the third region. As shown, the plurality of first elements 712 are of a larger scale than the pluralities of second and third elements 722 and 732, and the plurality of second elements 722 is of a relatively smaller scale than scale of both the pluralities of first and third elements 712 and 732. Like in FIGS. 5-6, the surface 701, therefore, provides for a variable friction grip surface. Relative to FIG. 6, in this embodiment, each element in the pluralities of elements 712, 722, and 732 are structured as projections (e.g., protrusions, protuberances, bulges, etc.) that are of a partial sphere-shape. As shown, each element in the pluralities of elements 712, 722, and 732 extend above a nominal level 702 of the surface 701. The taller (above the nominal level 702) and bigger the structure of the element, like the plurality of first elements 712, defines relatively more surface variation and a higher amount of friction. This type of element structure is used in the embodiment shown in FIG. 5.

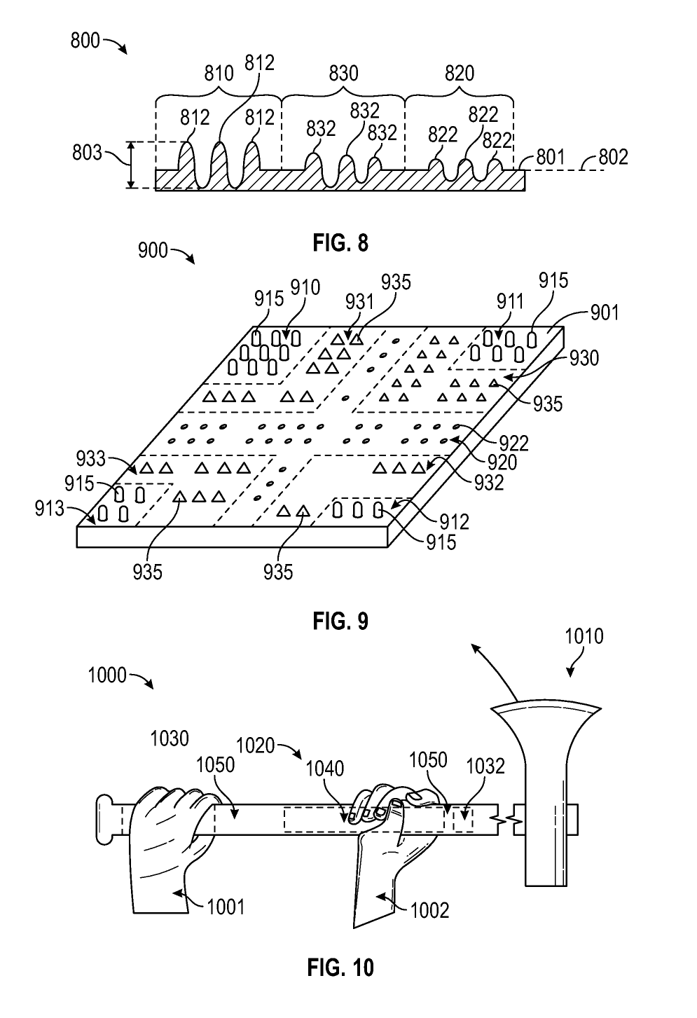

FIG. 8 depicts a grip structure 800 that includes a surface 801 that includes a first region 810, a second region 820, and a third region 830 interconnecting the first region 810 with the second region 820. The surface 801 defines a plurality of first elements 812 situated the first region 810, a plurality of second elements 822 situated in the second region 820, and a plurality of third elements 832 situated in the third region. As shown, the plurality of first elements 812 are of a larger scale than the pluralities of second and third elements 822 and 832, and the plurality of second elements 822 is of a relatively smaller scale than both the pluralities of first and third elements 812 and 832. Like in FIGS. 5-7, the surface 801 therefore provides a variable friction grip surface.

Relative to the previous element structures of FIGS. 1-7, the elements in each of the plurality of first elements 812, the plurality of second elements 822, and the plurality of third elements 832 extend both above and below a nominal level 802 of the surface 801. In this regard, the larger the deviation 803, the higher the coefficient of friction. Accordingly, the first region 810 defines relatively more friction than the second region 820, which provides a relatively smaller amount of friction than the third region 830. The varying scale of the plurality of third elements 832 provides a variable friction region that relatively smoothly transitions the frictional amounts between first and second regions 810 and 820.

While each of FIGS. 1-8 have depicted the variable friction grip surface as including elements of a homogenous shape, in other embodiments, the plurality of elements may be of a heterogeneous shape. For example, the plurality of first elements may correspond with a first shape, the plurality of second elements may correspond with a second shape, and the plurality of third elements may correspond with a third shape with at least one of the first, second, and third shapes being different from each other. Despite being of a different shape, the relative scales like described above may remain the same (e.g., the plurality of first elements is of the largest scale, the plurality of second elements is of the smallest scale, and the plurality of third elements is of a variable scale to smoothly interconnect and transition between the pluralities of first and second elements). In still further embodiments, more than one type of shape may be used with each plurality of elements. For example, the plurality of first elements may include elements of a raised pyramid and a raised partial sphere shape. However, the scale of these elements may still be relatively larger than the scale of the other plurality of elements in order to provide the variable friction grip surface.

One example embodiment is shown in FIG. 9. FIG. 9 depicts a variable friction grip surface 901 for a hand operated tool utilizing homogenous shaped elements for each region. As shown, the grip structure 900 includes a surface 901 that includes a first region 910, a second region 911, a third region 912, and a fourth region 913. Each of the first, second, third, and fourth regions 910-913 include a plurality of first elements 915. As shown, each of the first elements 915 are structured as partial-sphere shaped projections extending above the surface 901. The surface 901 also includes a fifth region 920 that includes a plurality of second elements 922. As shown, each of the plurality of second elements 922 are structured as partial-sphere shaped depressions extending into the grip structure 900. The surface 901 also includes a sixth region 930, a seventh region 931, an eighth region 932, and a ninth region 933. Each of the seventh through ninth regions 930-933 include a plurality of third elements 935. As shown, each of the plurality of third elements 935 are structured as pyramid-shaped projections extending above the surface 901.

Although the shapes are different for each plurality of elements, the scale of the plurality of first elements 915 is relatively larger than the scale of the pluralities of second and third elements 922 and 935 respectively. A variable scale is provided with the plurality of third elements 935. Accordingly, the provided friction by the surface 901 varies as a user moves their hand across the surface 901.

The size and relative locations of each region (and, therefore, the location of the highest and lowest amounts friction) may vary. This is in accord with FIGS. 1-4 that positioned the highest generating friction plurality of first elements around intended stationary hand positions for the hammer 100 and the lowest generating friction plurality of second elements around intended non-stationary hand positions for the hammer 100. Using a different set of shaped elements for each region may be useful for the user in quickly identifying, by feel (or by sight), locations of highest, intermediate, and least friction. In turn, a user may readily recognize and place their hand(s) in the location(s) best suited for the desired tool function (e.g., carrying the tool, using the tool, etc.).

As mentioned above, the variable friction grip surface of the present disclosure is structured to provide the highest amount of friction in areas where a user typically has a stationary hand position and the lowest amount of friction in areas where a user has a moving hand position. To avoid a discomfort in transitioning from high friction to low friction areas, a variable friction area is provided to relatively smoothly transition between the highest and lowest friction areas. This structure adds comfort, pleasant aesthetics, and improves function of the tool.

Referring now to FIGS. 10-12, use of a variable friction grip surface applied to a two-hand operated axe is shown through an impact stroke of the axe. FIG. 10 depicts a starting a position in the impact stroke, according to an exemplary embodiment. As shown, the axe 1000 includes a head 1010 and a variable friction grip surface 1020 that surrounds a handle operatively coupled to the head 1010. The surface 1020 is shown to include intended stationary hand position areas and intended movable hand position areas. The stationary hand position areas include a first region 1030 and a second region 1032. The movable hand position area includes a third region 1040. The stationary hand position area refers to an area where, in use of the tool, the hand of the user is intended to remain substantially stationary. The movable hand position area refers to an area where, in use of the tool, the hand of the user is intended to move or slide.

Regions 1030 and 1032 include a plurality of first elements that define a first friction level. Region 1040 includes a plurality of second elements that define a second friction level. The second friction level corresponds with the lowest amount of friction on the surface 1020, while the first friction level corresponds with the highest amount of friction on the surface 1020. Situated between the first region 1030 and the third region 1040 and the third region 1040 and the second region 1032 is the fourth region 1050. The fourth region 1050 corresponds with a variable friction level and includes a plurality of third elements. The plurality of first elements may be of characteristic as described herein in regard to the plurality of first elements. For example, the plurality of first elements may correspond with partial sphere shaped depressions (see FIG. 6), partial sphere shaped projections (see FIG. 7), a combination of above and below a nominal surface plane feature, and any other type of configuration. The same is true for the plurality of second elements and the plurality of third elements.

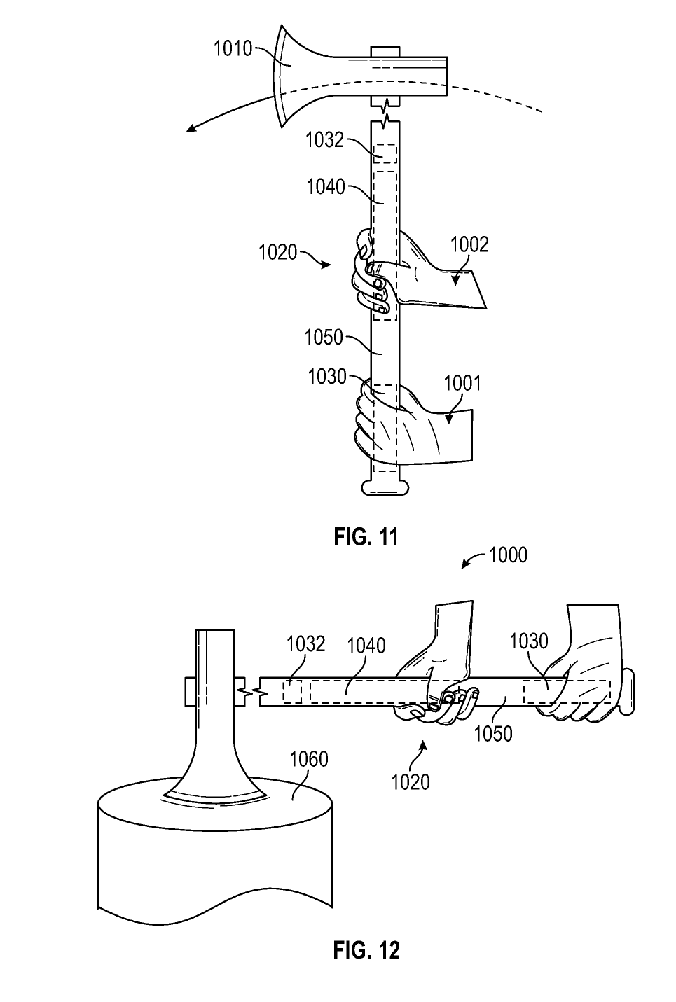

With the above structure in mind, in the starting position of FIG. 10, a first hand 1001 of the user is positioned in a stationary hand position area and a second hand 1002 of the user is positioned in an initial position of a movable hand position area. To ensure that a user has a relatively strong grip to maintain the first hand 1001 in the stationary hand position area throughout the impact stroke, the region 1030 with the plurality of first elements is disposed in that stationary hand position area. The relatively higher friction level provided in the region 1030 reduces the likelihood of the hand slipping during the stroke, which increases control over the tool 1000. As shown in FIG. 11, at an approximate midpoint of the impact stroke, the second hand 1002 of the user has slid down the grip surface 1020 towards the first hand 1001. To permit relatively easy sliding, the lowest friction region 1040 is provided in this movable hand position area. Near the end of the impact stroke, as the second hand 1002 has slid closer to the first hand 1001, the user may desire to increase their grip from their second hand 1002 in order to brace the tool for impact with the work piece 1060. To accommodate this desire, the region 1050 provides a variable friction level, increasing from the end of the region 1040 (the movable hand position area) towards the region 1030 (the stationary hand position area). As a result, the user's second hand 1002 experiences more and more friction as that hand moves in the region 1050 closer to the first hand 1001. This permits the user to apply a stronger grip from the second hand 1002, which increases the control over the tool 1000 as the user braces for impact with the work piece 1060. FIG. 12 depicts an end position of the impact stroke for the axe 1000. As shown, the first hand 1001 has remained stationary throughout the stroke while the second hand 1002 has moved to a minimal separation distance relative to the first hand 1001.

Due to the strategic locations of the high friction regions in the stationary hand position areas, the low friction regions in the movable position areas, and transitional friction regions to avoid uncomfortable and abrupt changes in a felt friction by the user, a user may operate the tool 1000 for longer periods of time without experiencing irritability caused by high friction areas in undesirable locations (e.g., inn the moving hand position area) and with a relatively greater amount of comfort and control.

Although the various features of the disclosure are shown and described above by way of example with reference to a hand operated tool (e.g., a hammer), the variable friction grip surface may be used with other tools as well, such as a chainsaw, that are not human powered. All such variations are intended to be within the scope of this disclosure.

Although specific examples are shown and described throughout this disclosure, the embodiments illustrated in the figures are shown by way of example, and any of a wide variety of other variable friction grip surface configurations (e.g., other types of texturing as compared to the elements shown herein) and tool configurations will be readily apparent to a person of ordinary skill in the art after reviewing this disclosure. All such variations of tools that use the variable friction grip surface are intended to be within the scope of the disclosure.

It is important to note that the construction and arrangement of the elements of the hand operated tool, shown as a hammer and an axe, with a variable friction grip surface shown schematically in the embodiments is illustrative only. Although only a few embodiments have been described in detail in this disclosure, those skilled in the art who review this disclosure will readily appreciate that many modifications are possible without materially departing from the novel teachings and advantages of the subject matter recited.

Accordingly, all such modifications are intended to be included within the scope of the present disclosure. Other substitutions, modifications, changes and omissions may be made in the design, operating conditions and arrangement of the preferred and other exemplary embodiments without departing from the spirit of the present disclosure. For example, the shape and position of the elements may be varied as necessary to accommodate changes in the dimensions, shape and geometry of the other components of the tool.

Furthermore, the order or sequence of any process or method steps may be varied or re-sequenced according to alternative embodiments. Other substitutions, modifications, changes and omissions may be made in the design, operating configuration and arrangement of the preferred and other exemplary embodiments without departing from the spirit of the present disclosure as expressed in the appended claims.

What is claimed is:

1. A hand operated tool, comprising:
a tool head;
a handle coupled to the tool head; and
a surface disposed on the handle, the surface defining:
a first plurality of elements situated in at least one first region on the surface, the at least one first region defining a first friction level;
a second plurality of elements situated in at least one second region on the surface, the at least one second region defining a second friction level, wherein the second friction level defines a relatively lesser amount of friction than the first friction level; and
a third plurality of elements defining a transitional friction level between the first friction level and the second friction level, the third plurality of elements interconnecting each of the at least one first regions with each of the at least one second regions;
wherein each element in the first, second, and third pluralities of elements are arranged on a dot matrix pattern.

2. The hand operated tool of claim 1, wherein each one of the at least one first region is positioned in an intended stationary hand position area on the surface, and wherein each one of the at least one second region is position in an intended movable hand position area on the surface.

3. The hand operated tool of claim 1,
wherein each element in the first, second, and third pluralities of elements has a same shape; and
wherein each element in the first plurality of elements is of a larger scale than each element in the first and second pluralities of elements.

4. The hand operated tool of claim 1,
wherein each element in the first plurality of elements has a first shape;
wherein each element in the second plurality of elements has a second shape;
wherein each element in the third plurality of elements has a third shape; and
wherein at least one of the first, second, and third shapes is different from another shape.

5. The hand operated tool of claim 1, wherein the first, second, and third pluralities of elements are at least one of above and below a nominal level of the surface.

6. The hand operated tool of claim 1, wherein a position of the least one first region and the at least one second region varies a function of a longitudinal distance away from the tool head.

7. The hand operated tool of claim 1, wherein a position of the least one first region and the at least one second region varies as a function of a circumferential position about the handle.

8. The hand operated tool of claim 1, wherein a shape of each element in the first, second, and third pluralities of elements include at least one of a partial sphere projection, a partial sphere depression, a pyramid projection, and a pyramid depression.

9. A hand operated tool including a surface for gripping a handle of the tool, the surface comprising:
at least one first region with a plurality of first elements in each at least one first region, wherein each at least one first region defines a first friction level, wherein each at least one first region is positioned on an intended stationary hand position area on the surface;
at least one second region with a second plurality elements in each at least one second region, wherein each at least one second region defines a second friction level defining a relatively lesser amount of friction than the first friction level, wherein each at least one second region is positioned in an intended movable hand position area on the surface; and
a third plurality of elements defining a transitional friction level between the first friction level and the second friction level, wherein the third plurality of elements interconnects each at least one first region with each at least one second region.

10. The surface of claim 9, wherein the transitional friction level ranges from the first frictional level to the second frictional level, wherein the third plurality of elements provides a relatively smooth frictional transition between each of the at least one first regions with each of the at least one second regions.

11. The surface of claim 9, wherein each element in the first, second, and third pluralities of elements are arranged on a dot matrix pattern.

12. The surface of claim 9,
wherein each element in the first, second, and third pluralities of elements has a same shape; and
wherein each element in the first plurality of elements is of a larger scale than each element in the first and second pluralities of elements.

13. The surface of claim 9,
wherein each element in the first plurality of elements has a first shape;
wherein each element in the second plurality of elements has a second shape;
wherein each element in the third plurality of elements has a third shape; and
wherein at least one of the first, second, and third shapes is different from another shape.

14. The surface of claim 9, wherein the first, second, and third pluralities of elements are at least one of above and below a nominal level of the surface.

15. The surface of claim 9, wherein a position of the least one first region and the at least one second region varies a function of a longitudinal position on the handle.

16. The surface of claim 9, wherein a position of the least one first region and the at least one second region varies as a function of a circumferential position about the handle.

17. A method for making a hand tool having a gripping surface with a variable friction pattern, the method comprising:
providing a first plurality of elements defining a first friction level, the first plurality of elements positioned on a stationary hand position area on the gripping surface;
providing a second plurality elements defining a second friction level, the second friction level being less than the first friction level, wherein the second plurality of elements are positioned on a movable hand position area on the gripping surface;
providing a third plurality of elements defining a transitional friction level between the first friction level and the second friction level; and
interconnecting the third plurality of elements with the first and second pluralities of elements.

18. The method of claim 17, wherein each element in the first, second, and third pluralities of elements are arranged on a dot matrix pattern.

19. The method of claim 17, wherein each element in the first, second, and third pluralities of elements are structured as at least one of a projection and a depression, wherein the depression extends below a nominal level of the gripping surface and the projection extends above the nominal level of the gripping surface.

20. The method of claim 17, wherein the hand operated tool includes at least one of an axe, a hammer, a sledgehammer, a maul, a lopper, a shears, and a pruner.
